(19) United States
(12) Patent Application Publication
(10) Pub. No.: US 2026/0326333 A1
(43) Pub. Date: Oct. 22, 2026

(54) METHOD AND SYSTEM FOR PROCESSING A LOG INTO SAWN TIMBER

(71) Applicant: Gebrüder Linck, Maschinenfabrik 'Gatterlinck' GmbH & Co. KG, Oberkirch (DE)

(72) Inventors: Lothar SEGER, Ihringen (DE); Raphael BURGER, Offenburg (DE); Martin RENDLER, Lautenbach (DE); Jörn RATHKE, Oberkirch (DE)

(73) Assignee: Gebrüder Linck, Maschinenfabrik 'Gatterlinck' GmbH & Co. KG, Oberkirch (DE)

(21) Appl. No.: 19/647,169

(22) Filed: Apr. 14, 2026

(30) Foreign Application Priority Data
Apr. 16, 2025 (EP) 25171001.8

(51) Int. Cl. B27B 1/00

(52) U.S. Cl. CPC B27B 1/007

(57) ABSTRACT

A method for processing at least one log (1) into sawn timber, in which the log or a workpiece produced from it is machined by at least one, in particular several, processing machines, and for this purpose, via at least one conveyor, a relative movement of the log or the workpiece produced from it is generated relative to at least one tool of the processing machine. At least one dimension and/or geometry of the log or the workpiece produced from it is determined prior to the machining, and for at least one of the processing machines, at least one performance-dependent processing parameter, in particular a torque (M1, M2, M3, M4) and/or a rotational speed (n1, n2, n3, n4) of a rotating tool (5, 6) of the processing machine, and/or a speed (v1, v2, v3) of the relative movement are set individually as a function of the determined dimension and/or geometry.

### CROSS-REFERENCE TO RELATED APPLICATIONS

This application claims priority from European Patent Application No. 25171001.8, filed Apr. 16, 2025, which is incorporated herein by reference as if fully set forth.

### TECHNICAL FIELD

The invention relates to a method and an apparatus for processing a log into sawn timber.

### BACKGROUND

When processing a log into sawn timber, the log is usually moved along a feed direction that is substantially parallel to its log axis against several cutting tools. The cutting tools may be rotating chipping tools, which are used to give the log flat side surfaces. The log is then usually processed in the area of the waney edges, for example by means of several profiling tools, by removing the remaining waney edge areas. In the profiling line variant, the main and side boards to be obtained are profiled contiguously and while still attached to the log. Subsequent scoring and sawing cuts, typically made using rotating saw blades, allow the side and main boards to be divided as required and separated both from the log and from each other. Alternatively, it is also possible to separate the boards from the log without first removing the waney edge area and then to feed them into a trimming circular saw to remove the waney edges.

For a cutting movement of the tools, in particular a rotation, the required aggregate power of a processing machine is usually determined and set permanently for the processing of the log. In addition, during the feed movement, a constant feed speed is usually set for several logs in order to achieve the required cycle times, at which the logs are conveyed through the processing machines. A disadvantage of such a setting of aggregate power and feed speed is the uneven load on the tools and the machine. This can lead to fluctuations in the cutting quality and a reduction in the service life of apparatus components, in particular tools.

### SUMMARY

The object of the invention is to provide means by which improved log processing is possible. The object is achieved by a method according having one or more of the features disclosed herein and an apparatus also having one or more of the features disclosed herein. Advantageous further developments are disclosed below and in the claims.

In the method according to the invention, a log or a workpiece produced from it is machined by means of at least one processing machine. For this purpose, at least one conveyor is used to generate a relative movement of the log or workpiece produced from it relative to at least one tool of the processing machine. Before machining, at least one dimension and/or geometry of the log or the workpiece produced from it is determined. For at least one of the processing machines, at least one performance-dependent processing parameter, in particular a torque and/or a rotational speed of a rotating tool of the processing machine, is set individually and, in particular, automatically as a function of the determined dimension and/or geometry and/or a variable dependent thereon. In addition or alternatively, a speed of the relative movement can also be set individually and, in particular, automatically for the individual setting of the performance-dependent processing parameter.

The individual adjustment of the performance-dependent processing parameter and/or the speed makes it possible to overcome the disadvantages of a fixed aggregate power and feed rate when processing logs by taking into account log-specific properties, which lead to better cutting quality and longer tool life when processing the respective log. This represents a departure from common principles in the processing of logs, as these are processed at constant speeds and aggregate outputs to ensure robust apparatus operation and compliance with specified cycle times. Within the scope of the invention, an individual setting can be regarded as a log-dependent configuration of the relevant variables. It is within the scope of the invention that the performance-dependent processing parameter can correspond to an aggregate power and/or a torque and/or a speed with which the tool in question is driven. It is also conceivable that the aggregate power remains substantially constant and the torque and rotational speed, of which the product corresponds to the aggregate power, are adjusted. In particular, the individual adjustment of the power-dependent processing parameter and/or the feed rate comprises a change in the aforementioned variables between the processing of two logs or workpieces produced from them, in particular an increase or a decrease.

According to the invention, it is fundamentally irrelevant what type of relative movement is set between the log and the tool. In this respect, it is conceivable that the log and the tool can be moved individually or together, in particular in the same or opposite directions, in order to adjust the relative movement. The speed of the relative movement can result from the joint movement of the log or workpiece produced from it and the tool, in particular depending on the respective speeds along a common reference axis. Similarly, the log or the workpiece produced from it can be conveyed through the processing machine by means of the conveyor at a feed rate in a feed direction and processed by means of the tool. In this case, the tool can be arranged in a fixed position at least in relation to the conveyor axis of the log, so that the speed of the relative movement corresponds to the feed rate of the log or the workpiece produced from it. In particular, the feed rate in this case is to be regarded as independent of a cutting movement of the processing tool in question, in particular a tangential component during rotation of the processing tool.

The invention is based on the realization that, in the cutting machining of wood, the specific cutting force, cutting depth, cutting width, and tool geometry, in particular the tool diameter of a rotating tool, are selected depending on the profile to be given to the log to be machined. This in turn depends on the maximum wood yield that can be achieved, which in turn depends on the shape of the log, which can vary from log to log due to natural growth. Of the factors mentioned, the cutting depth and cutting width in particular determine the volume of wood that is removed from the log or workpiece produced from it in a machining manner, and thus also the power required to process the log in the desired manner. By recording the dimensions and/or geometry of the log or a workpiece produced from it, it is possible at an early stage of log processing to determine the cutting depths and cutting widths with which the log is likely to have to be processed in order to produce a desired profile on the log and the performance-dependent processing parameters and/or feed rate that should be optimally set. In other words, by adjusting at least one performance-dependent processing parameter and/or the feed rate to suit requirements, it is possible to optimize the energy efficiency of the system at machine level, improve the cutting quality, and reduce tool wear, depending on the determined shape of the log. It is also possible to dynamically calculate and adjust the feed rate, thereby achieving a dynamic line feed with which the processing of the logs or workpieces produced from them, in particular model and/or square timber, can be carried out at the individual optimum performance level in each case. Preferably, the aggregate power and/or feed rate of the log can be set individually and as required in the case of processing by several processing machines within a processing line.

A reduction in the feed speed as required can result in the tool being able to remove the required amount of material at a given aggregate power, thereby avoiding unclean cuts or surface cracks. Conversely, increasing the feed rate can be advantageous in order to respond to increasing material resistance, which extends the service life of the tools and makes the use of the processing machine more efficient. In addition, rigid feed speeds can cause irregular loads on the tools, especially when processing logs with different properties such as wood type, moisture content, or density. This can lead to overloads or inefficient energy consumption, as the machine must always be designed for maximum performance and operated at a corresponding power point, even if this is not required continuously. As a result, not only does energy consumption increase, but so does tool wear, as the tools are subjected to uneven stress. Adjusting the feed rate makes it possible to avoid these disadvantages.

Changing a performance-dependent processing parameter while keeping the feed rate constant offers several advantages for processing logs. By increasing the power, the tool can apply greater cutting forces, which enables more efficient machining. This leads to more uniform machining, as the tool always achieves the required material removal rate even with harder or moist wood without reaching its performance limits. Another advantage of the invention is the improved cutting quality. Since the aggregate power can be increased as needed, the material can be cut more cleanly, resulting in more precise cuts and smoother surfaces. At the same time, the risk of cracks or unclean cuts is reduced, as the tool does not slow down or start to tear under load, but works through the wood at a constant speed. This results in lower mechanical stress on the cutting tool, which reduces wear and tear and extends maintenance intervals. In addition to the features mentioned, from an economic point of view, it is important to process the logs or workpieces produced from them at optimum performance, so that the invention described includes a log-specific calculation of all performance-related features and, accordingly, the ideal feed rate or speed is calculated for each individual processing step and executed accordingly.

The performance-dependent processing parameter can basically be regarded as any parameter that is related to the aggregate performance of the relevant processing machine and/or corresponding tool. This can be the aggregate power itself, a drive torque and/or speed of the tool or a mechanically coupled drive element. It is within the scope of the invention that the processing parameter is changed and the feed rate remains constant, or vice versa. It is also within the scope of the invention that both the processing parameter and the feed rate are adjusted.

Furthermore, it is within the scope of the invention that the dimensions and/or geometry of the log or workpiece produced from it are only indirectly taken into account for the individual adjustment of the power-dependent processing parameter and the feed rate. In particular, it is conceivable that the recorded dimensions and/or geometry are first used to determine a cutting solution and that the performance-dependent processing parameter and the feed rate are adjusted depending on the cutting solution. Within the scope of the invention, the cutting solution can be regarded as an arrangement of boards to be obtained in relation to the log geometry or the workpiece obtained from the log.

The dimension and/or geometry can be determined using one or more sensors, which can be designed in particular as optical sensors and determine and output two-dimensional and/or three-dimensional geometry information about the log or the workpiece obtained from it. It is within the scope of the invention that a measuring device is arranged in a fixed position and that the log passes through a detection area of the measuring device during its transport movement, in which the dimensions and/or geometry of the log are detected, in particular in the form of a point cloud, which is then processed into a digital log model.

In an advantageous development, the log or the workpiece produced from it is partially processed into wood chips and/or shavings by cutting, and the cutting parameters and/or the feed rate are set depending on a nominal wood chip property or shaving property.

The further processing described above is based on the knowledge that the processing of logs produces wood chips and/or shavings, which are merely a by-product in the production of wooden boards, but the resale of which can lead to good economic efficiency in log processing. In order for the aforementioned wood chips or shavings to be reused with a high material yield, they must have regularly specified properties, particularly with regard to size and/or shape. It is a surprising finding that the wood chip or shaving properties required for further processing can be achieved depending on the feed rate and/or the performance-dependent processing parameter. Therefore, the advantageous development is based on the reverse conclusion that the feed rate and the performance-dependent processing parameter can be adjusted to obtain wood chips or shavings with a predefined nominal property. It is within the scope of the advantageous development that there is a natural variance in the wood chips or shavings actually produced with regard to the relevant wood chip property or shaving property. However, investigations by the applicant have shown that the reusability of wood chips or shavings can be sufficiently ensured if the desired wood chip geometry or shaving property is specified with a nominal size, for example, an average wood chip or shaving shape and/or wood chip or shaving geometry.

In a simple embodiment, a wood chip property or chip property, which, as indicated above, can be a wood chip size or wood chip geometry, can be directly dependent on the performance-related processing parameter, in particular the torque and/or rotational speed of a rotating tool of the processing machine, and/or the feed speed at which the log or the workpiece produced from it is fed through the processing machine for machining. This relationship can be determined experimentally or mathematically and form the basis for a model that represents the relationship. In particular, the model may be a computational model or a model based on artificial intelligence, which indicates a relationship between a nominal wood chip property or chip size and the at least one performance-dependent processing parameter and/or the feed rate of the log. The setting of the at least one performance-dependent processing parameter and/or the feed rate of the log can be automated. It is also conceivable that the setting is made manually, with an apparatus operator using a table or comparable basis to determine which performance-dependent processing parameters and/or feed rate of the log must be set in order to obtain wood chips with specific properties.

In an advantageous development, the processing parameter and the feed rate of the processing machine are set in such a way that, by machining two logs of different dimensions, wood chips with substantially uniform nominal properties, in particular a substantially uniform wood chip size and/or substantially uniform wood chip geometry, are produced.

In an advantageous development, the processing machines within an apparatus are connected to each other by means of a conveyor system, and different feed rates are set within the apparatus depending on the dimensions and/or geometry of the log or a size derived therefrom. In particular, different feed rates and/or performance-related processing parameters are set for at least two processing machines for processing the same log or workpiece produced from it, with which the log and/or the workpiece produced from it is conveyed through the processing machines and in so doing is processed.

In an advantageous development, the performance-related processing parameters and/or the feed rates at which the log and/or the workpiece produced from it is conveyed through the at least two processing machines are set depending on nominal aggregate performances and the respective cutting surfaces.

The cutting surface parameter can be regarded as the area of the chip to be removed in a specific cutting plane. The cutting surface indicates how much material the tool penetrates per cut and is an important variable for determining the cutting force and machining performance. In particular, the cutting surface may result from a cutting solution according to which the log or the workpiece obtained from it is to be machined. In the context of the advantageous development, the cutting surface can be regarded as a variable dependent on the dimensions and/or geometry of the log or the workpiece produced from it. In particular, the cutting surface depends on the geometry of the tool of the processing machine in question.

In an advantageous development, the performance-dependent processing parameters and/or the feed rates are determined and individually adjusted depending on the determined dimensions and/or geometry, wherein during and/or after the machining of the log or the workpiece produced from it, a comparison is made between a determined aggregate power and the actual aggregate power consumed by the processing machine.

The development described above forms the basis for dynamic optimization in the processing of logs, by means of which various performance-dependent processing parameters, e.g., the aggregate power itself, and/or feed rates can be adjusted in real time. The processing machine can dynamically adjust its power consumption and feed rate to the respective log instead of working with fixed standard values. At the same time, a check is made to see whether the power actually consumed corresponds to the previously calculated values in order to detect possible efficiency losses at an early stage. This process ensures optimized processing, reduces costs, and extends the service life of the tools.

The aggregate power, e.g., the motor power of the milling cutter or saw blade, and the feed rate are not set at a fixed value, but are adjusted to the determined dimensions or geometry of the log. This means that each log is processed individually to maximize efficiency. For example, a thicker log or particularly hard wood requires higher power, while thinner logs or softer wood require less energy.

During or after processing, the actual power consumption of the processing machine is preferably compared with the pre-calculated power. This serves to identify deviations and readjust the system if necessary. If the machine consumes more power than expected, this could indicate a problem such as tool wear, a faulty setting, or unexpected material hardness.

The power consumption of a processing machine can be easily determined by measuring the electrical power supplied to the machine. This value indicates how much energy the machine actually needs to perform the processing operation. The power can be determined using various methods, such as direct electrical power measurement, in which current sensors measure the current flow to the motor and voltage values are recorded via voltage transformers, so that the electrical power can be deduced from the product of the aforementioned measured variables. The power can also be calculated by measuring the torque and speed at the motor and/or directly at the rotating tool. For this purpose, a torque transducer can measure the torque and the rotational speed can be recorded via a speed sensor or encoder of an electric machine. Similarly, the base load of the machine (idle power) and the power consumption during machining can be determined by suitably designing the machine control system, for example by using sensors. The difference between the two power ratings indicates the energy consumption for chip removal.

In an advantageous development, a correction is made for the power-related processing parameter and/or the feed rate depending on a deviation between the determined drive power and the actual drive power consumed. The correction can be made during the processing of the log or taken into account for the processing of another log that follows in the processing sequence.

In an advantageous development, tool wear is determined and/or predicted depending on a deviation between the determined aggregate power and the actual aggregate power consumed. The tool wear can be represented by one or more key figures which indicate a condition or change in condition of the tool as a result of its use. It is possible that the key figure indicates a remaining service life or total service life of the tool, which was previously determined experimentally or mathematically. It is also conceivable that the determination of tool wear is based on a model, which may be based in particular on artificial intelligence or may be created analytically.

The object is also achieved by an apparatus for processing a log into sawn timber. The apparatus comprises at least one, preferably several, processing machines for machining the log or a workpiece produced from it, wherein the at least one processing machine has an adjustable performance-dependent processing parameter, in particular a torque and/or a rotational speed of a rotating tool of the processing machine. The apparatus also comprises a measuring device which is designed to record a dimension and/or geometry of the log. The system also has a conveyor which is designed to generate a relative movement between the log or workpiece produced from it and at least one tool of the processing machine for machining. The system also has a controller which is connected for signal exchange at least to the measuring device, conveyor and the processing machine and is designed to individually adjust at least the processing parameters of the processing machine and/or a speed of the relative movement depending on the determined dimension and/or geometry.

The system is preferably suitable for carrying out the method according to the invention or an advantageous development thereof. Accordingly, the embodiments relating to the method according to the invention and its advantageous developments are transferable to the apparatus.

In an advantageous development, at least one of the processing machines is a chipping unit, which comprises at least one rotatably mounted cutter head unit for producing a broad side of a board on the log or on the workpiece produced from it, as well as at least one drive unit connected thereto, which is connected to the controller for signal exchange.

In an advantageous development, at least one of the processing machines is a profiling unit, which comprises at least one rotatably mounted milling head for profiling a narrow side of a board on the log or workpiece produced from it, as well as a drive unit connected to it, which is connected to the controller for signal exchange.

In an advantageous development, at least one of the processing machines is a sawing unit, which comprises at least one rotatably mounted saw blade for separating one or more boards from the log and/or for scoring one or more boards on the log, as well as at least one drive unit connected thereto, which is connected to the controller for signal exchange. The sawing unit may also be provided for trimming a board that has already been cut from the log.

Preferably, at least the chipping unit and/or the profiling unit and/or the sawing unit are connected to each other by means of the conveyor. The apparatus is designed to accommodate several logs or workpieces of different dimensions and/or geometries produced from them and to process them at different feed rates by means of the chipping unit and/or the profiling unit and/or the sawing unit.

### BRIEF DESCRIPTION OF THE DRAWINGS

One embodiment of the invention is explained below by way of example with reference to the drawings, in which:

FIG. 1 illustrates the machining of a log 1, which is to be processed into sawn timber. This includes the production of boards and the manufacture of wood chips and shavings.

### DETAILED DESCRIPTION

For processing, the log 1 is first moved along its log axis 2 to a measuring device 3, which in the exemplary embodiment shown here comprises two profile scanners, by means of which the log 1 is measured and its geometry and dimensions are determined. For simplicity, the log 1 shown here has a substantially cylindrical geometry, but in reality it may be non-circular and curved due to the natural growth of the log.

The information recorded by the measuring device 3 is transmitted to a controller 4 via a data connection. The controller 4 is equipped with an evaluation routine implemented on it to determine how many and what types of boards can be optimally obtained from the log 1 and, for this purpose, determines a so-called cutting solution, which comprises the achievable arrangement and dimensions of the boards in relation to the log geometry and which differs from log to log.

Since the orientation of the obtainable boards relative to the log geometry may be rotated relative to a horizontal or vertical reference plane during the measurement of the log 1, the log 1 is usually rotated about its log axis 2 during the conveying movement. This brings the log 1 with its boards to be harvested into an optimal alignment with the cutting tools used, which in this case are a rotating chipping head 5 of a chipping unit and two rotating profiling heads 6 of a profiling unit, a scoring saw 9, and two saw blades 10.

In order for the log 1 to be processed in the desired manner for maximum wood yield using the chipping head 5 and the profiling heads 6, the cutting depths and cutting widths that must be set for the chipping head 5 and the profiling heads 6 are determined based on the dimensions and geometry of the log 1, which are recorded using the measuring device 3. This results in a first cutting surface 7 for processing using the chipping head 5 and a second cutting surface 8 for subsequent processing using the profiling heads 6. The cutting surfaces 7 and 8 are those surfaces in which the chipping head 5 and the profiling heads 6, respectively, come into cutting contact with the log 1 when viewed in the feed direction.

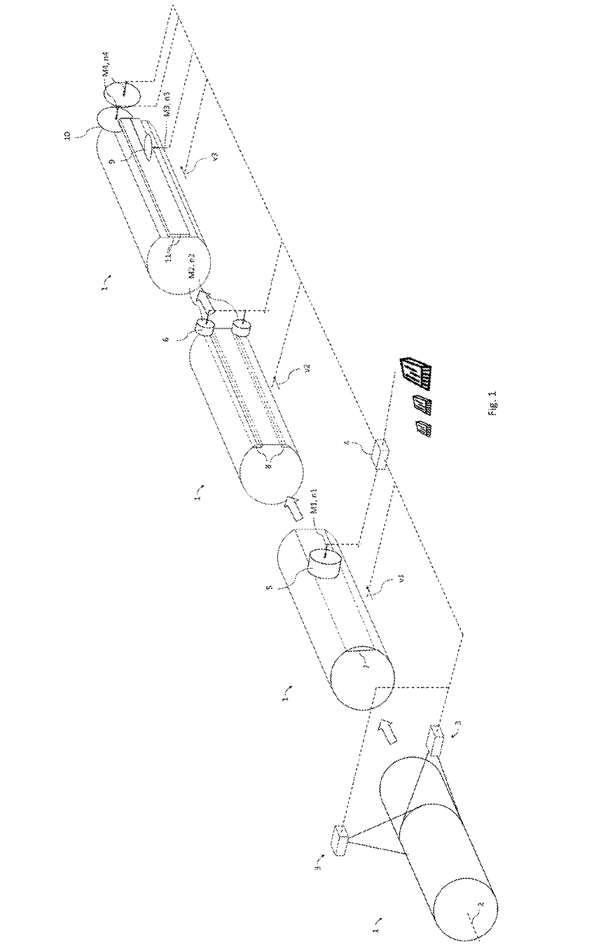

A special feature of the method shown in FIG. 1 and the system used for it is that the aggregate power of the chipping aggregate and the profiling aggregate is adjusted depending on the dimensions and geometry of the log 1 by adjusting the torques M1, M2, the speeds n1, n2, and the feed rates v1, v2 as required and individually. This makes it possible to achieve optimum processing of the log 1 in terms of cutting quality and to reduce tool wear based on the log geometry.

Another important aspect is that the above-mentioned performance-related processing parameters are not only adjusted depending on the dimensions and geometry of the log 1, but also depending on a nominal wood chip property, in this case a desired wood chip size.

The setting of the performance-related processing parameters is based on the knowledge that the wood chips produced during the cutting of the log 1 may have properties that influence their further processability. If wood chips are to be used for the manufacture of components, for example, it is necessary to ensure that they have the desired sizes and shapes so that the desired quality of the component can be guaranteed. At the same time, it has been recognized that the performance-related processing parameters of a chipping unit or a profiling unit and the feed rate of the log have a direct influence on the wood chip geometry and wood chip size. By adjusting the processing parameters and feed rate accordingly, it is therefore possible to produce wood chips with the desired wood chip geometry and size. This enables the process to be carried out economically and the apparatus used to carry out the process to be operated economically. The required wood chip properties are entered into the controller 4 for this purpose.

The findings regarding the relationship between wood chips or their properties and the performance-related processing parameters and/or the feed rate apply accordingly to chips or their properties. Accordingly, after profiling, the log 1 is first cut with a scoring saw 9, thereby dividing a board profiled on the log side. The board divided in this way is then separated from the log 1 by means of two saw blades 10. The performance-related processing parameters in the form of a scoring saw torque M3 and a scoring saw speed n3, as well as the saw blade torque M4 and the saw blade speed n4, are set individually and depend on the dimensions and/or geometry of the log, as well as on the desired chip geometry. The cutting surface 11 depends on the cutting depth and thickness of the saw blades and can therefore correspond to the area in which the respective saw blade 9, 10 is in cutting engagement with the log 1 and can be determined depending on the geometry of the log 1.

Another relevant aspect is that during or after the processing of the log 1 or a workpiece produced from it, a comparison is made between a previously calculated aggregate power, which is derived from the power-related processing parameters, and an actual aggregate power consumed.

In the embodiment shown here, this is done by measuring the electrical power supplied to the machine that causes the rotational movement of the chipping head 5 or the profiling heads 6 or the scoring saw 9 or the saw blades 10. This is done using a current sensor and a voltage sensor, which output corresponding current and voltage measurements, respectively, on the basis of which the actual power during the machining of the log 1 or the workpiece produced from it can be determined.

Alternatively, the power can be calculated by measuring the torque and speed at the motor and/or directly at the rotating tool 5 or 6 or 9 or 10. For this purpose, a torque transducer can measure the torque and the rotational speed can be recorded via a speed sensor or encoder of an electric machine.

If there is a deviation between the determined aggregate power and the actual aggregate power consumed, a correction can be made for the calculation of the power-related processing parameters. Overall, this results in a self-optimizing system in which an initial error in determining and setting the power-related processing parameter or feed rate can be gradually reduced.

In addition, tool wear can be determined or predicted depending on a deviation between the determined aggregate power and the actual absorbed aggregate power. In particular, this can be expressed in terms of an estimated tool life or remaining service life. This makes it possible to plan maintenance intervals and schedule apparatus downtimes in such a way that they have only a minor impact on overall economic efficiency.

The principles described in FIG. 1 can also be applied to apparatus configurations not shown here. In particular, it is conceivable that no profiling unit is used and a board is separated from the log 1 without first removing the waney area. In this case, the board can be fed to a trimming circular saw, which separates the remaining waney area from the board, wherein at least one performance-related parameter and/or the feed rate is adjusted depending on the dimensions and/or geometry of the log.

1. A method for processing a log (1) into sawn timber, the method comprising:
machining the log (1) or a workpiece produced therefrom from by at least one processing machine, and for said machining, using a conveyor for generating a relative movement of the log (1) or the workpiece relative to at least one tool of the at least one processing machine;
determining at least one dimension and/or geometry of the log (1) or the workpiece produced therefrom prior to the machining; and
for at least one of the at least one processing machine, individually setting at least one performance-dependent processing parameter, including at least one of a torque (M1, M2, M3, M4) or a rotational speed (n1, n2, n3, n4) of a rotating tool (5, 6) of the at least one processing machine, and a speed (v1, v2, v3) of the relative movement as a function of the determined at least one dimension and/or geometry.

2. The method as claimed in claim 1, wherein
the log or the workpiece produced therefrom is conveyed through the at least one processing machine by the conveyor at a speed that corresponds to a feed rate (v1, v2, v3) in a feed direction and is machined by the at least one tool.

3. The method as claimed in claim 1, wherein
the log (1) or the workpiece (1) produced therefrom is partially machined into wood chips and/or shavings, and the method further comprises setting the torque, the rotational speed (M1, M2, M3, M4, n1, n2, n3, n4) and/or the speed of the relative movement depending on a nominal wood chip property and/or shaving property.

4. The method as claimed in claim 3, wherein the speed of relative movement is a feed rate (v1, v2, v3) of the conveyor in a feed direction, and the torque, the rotational speed (M1, M2, M3, M4, n1, n2, n3, n4) ,and the method further comprises setting the feed rate (v1, v2, v3) of the processing machine such that, in machining two logs of different dimensions, the wood chips and/or the shavings are produced with the nominal wood chip property and/or the shaving property being substantially uniform.

5. The method of claim 4, wherein the wood chips and/or the shavings are produced with a substantially uniform wood chip size and/or shaving size and/or substantially uniform wood chip geometry and/or shaving geometry.

6. The method as claimed in claim 1, wherein
there at least two of the processing machines within an apparatus that are connected to each other by a conveyor system and the method further comprises, depending on the dimensions and/or geometry within the apparatus, setting different speeds of the log or workpiece produced there from, with which the log (1) and/or the workpiece (1) produced therefrom is conveyed through the processing machines and machined.

7. The method of claim 6, wherein the different speeds are variable speeds.

8. The method as claimed in claim 6, wherein
the different speeds are set for the at least two processing machines for processing one and the same log or workpiece produced therefrom, at which speeds the log (1) and/or the workpiece (1) produced therefrom is conveyed through the processing machines and machined.

9. The method as claimed in claim 8, wherein
the performance-dependent processing parameters (M1, M2, M3, M4, n1, n2, n3, n4) and/or the speeds at which the log (1) and/or the workpiece (1) produced therefrom is conveyed through the at least two processing machines, are set depending on nominal aggregate outputs and/or respective cutting surfaces (7, 8).

10. The method as claimed in claim 1, wherein
the performance-dependent processing parameters (M1, M2, M3, M4, n1, n2, n3, n4) and/or the speeds, are determined and individually adjusted as a function of the determined dimensions and/or the geometry, and during or after the processing of the log or the workpiece produced therefrom, the method further comprising making a comparison between a determined aggregate power and an actual aggregate power consumed by the processing machine.

11. The method as claimed in claim 10, further comprising
making a correction for the performance-related processing parameter (M1, M2, M3, M4, n1, n2, n3, n4) and/or the speed.

12. The method of claim 11, wherein making the correction comprises correcting the speed which corresponds to a feed rate (v1, v2, v3) of the conveyor, depending on a deviation between the determined aggregate power and the actual aggregate power consumed.

13. The method as claimed in claim 10, further comprising determining and/or predicting tool wear depending on a deviation between the determined aggregate performance and the actual aggregate performance.

14. An apparatus for processing a log (1) into sawn timber, the apparatus comprising;
a measuring device (3) that is adapted to detect a dimension and/or geometry of the log (1);
at least one processing machine for machining the log (1) or a workpiece (1) produced therefrom, wherein the at least one processing machine has an adjustable processing parameter (M1, M2, M3, M4, n1, n2, n3, n4), including at least one of a torque (M1, M2, M3, M4) or a rotational speed (n1, n2, n3, n4) of a rotating tool of the processing machine;
a conveyor that is adapted to generate a relative movement between the log (1) or the workpiece (1) produced therefrom it and at least one tool of the at least one processing machine for machining; and
a controller (4) which is connected for signal exchange at least to the measuring device (3), the conveyor, and the at least one processing machine and is configured to individually adjust the at least one processing parameter (M1, M2, M3, M4, n1, n2, n3, n4) of the processing machine and/or a speed of the relative movement (v1, v2, v3) depending on the determined dimension and/or geometry.

15. The system as claimed in claim 14, wherein
the at least one of the processing machine includes a chipping unit, which comprises at least one rotatably mounted chipping head (5) for producing a broad side of a board on the log or on the workpiece produced therefrom, as well as at least one drive unit connected thereto, which is connected to the controller (4) for signal exchange.

16. The system as claimed in claim 15, wherein
the at least one processing machine comprises a profiling unit, which comprises at least one rotatably mounted profiling head (6) for profiling a narrow side of a board on the log or on the workpiece produced therefrom, as well as a drive unit connected thereto, which is connected to the controller (4) for signal exchange.

17. The system as claimed in claim 16, wherein
the at least one processing machine comprises a sawing unit which comprises at least one rotatably mounted saw blade (9, 10) for cutting or scoring or trimming one or more boards, and at least one drive unit connected thereto which is connected to the controller (4) for signal exchange.

18. The system as claimed in claim 17, wherein
at least the chipping unit and/or the profiling unit and/or the sawing unit are connected to one another by the conveyor system, and the system is adapted to accommodate several logs or workpieces of different dimensions and/or geometries produced therefrom and to process the several logs or workpieces of different dimensions and/or geometries at different speeds and/or with different processing parameters by the chipping unit and/or the profiling unit and/or the sawing unit.
